(19) United States
(12) Patent Application Publication
(10) Pub. No.: US 2007/0027769 A1
(43) Pub. Date: Feb. 1, 2007

(54) Method for redeeming frequent flier mileage

(76) Inventor: Lewis Bender, Redding, CT (US)

Correspondence Address: EDWARDS & ANGELL, LLP, P.O. BOX 55874, BOSTON, MA, 02205, US

(21) Appl. No.: 11/495,373

(22) Filed: Jul. 28, 2006

Related U.S. Application Data
(60) Provisional application No. 60/704,228, filed on Jul. 29, 2005.

(51) Int. Cl. G06Q 30/00; G06Q 10/00

(52) U.S. Cl. 705/14; 705/5

(57) ABSTRACT

A method, system and computer program for redeeming frequent flier miles to purchase a good or service are provided. An exemplary embodiment of the method includes receiving a first set of information from a user including one or more preferences of the user and determining availability of a good or a service substantially consistent with the preferences received from the user. The method further includes determining a number of frequent flier miles necessary to purchase the good or service. Determining the number of frequent flier miles needed includes determining at least one of a demand and a cost for the good or service based on information affecting the value of the good or service, as well as establishing a number of miles that correlates to the determined demand or cost. The method also includes sending a signal representative of the number of miles needed to obtain the good or service.

### CROSS-REFERENCE TO RELATED APPLICATION

This application claims the benefit of priority from U.S. Provisional Patent Application Ser. No. 60/704,228 filed Jul. 29, 2005, the disclosure of which is incorporated by reference herein in its entirety.

### FIELD OF THE INVENTION

The subject invention is directed generally to methods for redeeming frequent flier miles.

### BACKGROUND OF THE RELATED ART

Virtually all airlines utilize some sort of “frequent flier” program. In these programs, a customer accumulates “miles”, either through previous flights with the concerned airline or through other mechanisms, such as credit card promotions in which miles are accumulated in proportion to the amount spent with the credit card. These accumulated miles can later be “redeemed” in purchasing flights or upgrading flying conditions, e.g., from coach to first class.

As they are presently structured, most frequent flier programs are difficult for customers to utilize, for several reasons. First, airlines significantly limit the availability of flights that can be purchased with frequent flier miles. Second, for flights that can be purchased with frequent flier miles, a substantial lead-time is required when reserving a seat via frequent flier miles redemption. Finally, airlines often utilize a very coarse pricing scheme when determining the number of miles that must be redeemed for each flight, and an equally coarse method of modifying price (in miles) based on demand. Both practices often serve to prohibit purchase of flights through miles redemption and do not represent the “free market” price of such flights. For example, many airlines will simply charge a standard rate, say, 25,000 miles, to travel to a variety of destinations, regardless of the price in dollars. As another example, the Delta SkyChoice® program operates by simply doubling the required number of miles (over the amount that would normally be required) for purchase at more desirable times.

All of these issues experienced with conventional frequent filer programs have some relationship to the lack of relationship between flight pricing, in frequent flier miles, and flight demand Without such a relationship, the airlines are forced to resort to schemes that may deter the use of frequent flier miles in an effort to assure profitability. However, this practice can result in frequent flier miles remaining unused and flights operating at less than full capacity, outcomes that harm both the customer and the airline. The disclosed invention provides a solution to these and other problems.

### SUMMARY OF THE INVENTION

The present disclosure is directed to a method, system and machine readable program, as appropriate, for determining a number of frequent flier miles necessary to purchase a good or service. In accordance with one aspect of the invention, the method includes determining a demand for an airline ticket or class upgrade based, for example, on market data related to a travel destination associated with the ticket. The number of miles required to purchase the ticket or upgrade is established to correlate to the determined demand and/or cost.

A method, system and machine readable program as described above avoids many of the issues currently experienced when using a frequent flier program to purchase airline tickets. These and other aspects of the subject invention will become more readily apparent from the following brief description of the drawings taken in conjunction with the enabling description of the invention.

### BRIEF DESCRIPTION OF THE DRAWINGS

So that those having ordinary skill in the art to which the subject invention appertains will more readily understand how to make and use the same, reference may be had to the drawing wherein:

FIG. 1 is a flow chart representing a method for redeeming frequent flier miles over the Internet;

FIG. 2 is a flow chart representing a method for redeeming frequent flier miles over the telephone; and

FIG. 3 is a flow chart representing a method for redeeming frequent flier miles over the Internet or the telephone.

### ENABLING DESCRIPTION OF THE INVENTION

The present invention involves a new valuation method, and associated system and machine readable program for airline travel purchase by frequent flier miles, the valuation method bearing a relationship to market forces. In one embodiment, the valuation method can follow traditionally accepted principles of supply and demand economics, such that prices in miles for any of the destinations to which an airline travels can be tailored to the desirability of that destination at that time of travel. In another embodiment, the valuation method can maximize profit given above inputs relative to other flights. In still another embodiment, “miles prices” can result from a direct correlation between dollars and miles, such that the dollar price of the flight can be proportional to the miles price.

If desired, an algorithm to calculate the appropriate miles price can be provided that is uniquely structured to reflect mileage redemption patterns. Specifically, one form of the frequent flier miles valuation algorithm can include parameters such as the number of passengers, the departure city, the destination, the departure date, the return date, the class of in-flight accommodations, the acceptable number of stops, and the number of days in advance of departure that purchase is sought. Additionally, the algorithm might relate to parameters such as the type of plane, the desirability of the destination (potentially as a function of date), the availability of seats on a flight, the price of fuel or other consumables, the crew size, the ticket price, and certain customer characteristics (e.g., “preferred customer”, etc.).

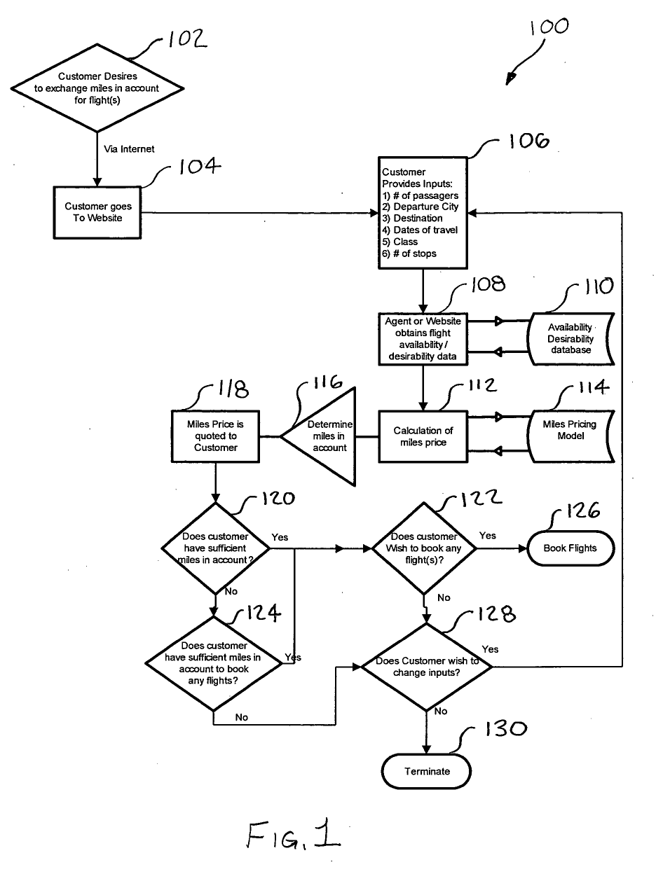

The present invention is also directed to a process for redeeming frequent flier miles over the Internet, a representative embodiment of such process is illustrated schematically in the flow chart of FIG. 1 and labeled 100. At step 102, process 100 begins with a frequent flier customer deciding to redeem/exchange miles for a flight. At step 104, the customer accesses the airline web site, which at step 106 allows the customer to input information including the number of passengers that desire travel, the departure and destination cities, the dates of travel, the level of flight accommodations (e.g., coach, first class), and the allowable number of stops for the flight. For example, the web site can display a series of fields within which a user enters the information. This information is received, at step 108, and utilized, at step 110, to search a database of available flights to locate those flights matching the criteria entered by the user. The receipt and search of steps 108 and 110 can be performed by an agent who physically or electronically accesses a database, or more preferably, can be automated into an electronic process. In a particular embodiment of the process 100, search step 110 returns not only information for flights matching all of the criteria entered by the customer, but flights matching a substantial number of user inputs as well.

When one or more flights matching the entered criteria have been identified, the number of frequent flier miles required to purchase the flight is calculated. The flight information is input at step 112 into a “miles pricing model” 114, which returns the appropriate cost in frequent flier miles for the flight. The miles pricing model 114 incorporates concepts related to demand for flights in calculating a “miles price” for the particular flight in question. At step 116, the number of frequent flier miles that the customer has accumulated is determined, typically by examining a frequent flier miles account specific to the airline. At step 118, the miles price for the flight(s) is quoted to the customer. At step 120, the miles price is compared to the number of miles in the customer's frequent flier account to determine whether the customer has sufficient miles to purchase the flight. As before, this comparison can be done manually by an agent or can be automated into an electronic process. If the customer does have sufficient miles to purchase a flight, at step 122 the customer may accept at step 126 or decline. If the customer declines to purchase the flight, at step 128 the customer is asked if he/she desires to make changes to the criteria information originally input at step 106. If the customer does wish to do so, he/she is returned to step 106 to enter new information and repeat process 100. Otherwise, the process 100 is terminated at 130.

If, at step 120, it is determined that the customer does not have a sufficient number of miles to purchase any flight matching the entered criteria, at step 124 the system determines whether the customer has sufficient miles to book any flights matching at least some of the entered criteria. For example, a customer may have sought to purchase two tickets, but can only afford one. Alternatively, the miles/pricing software can also be developed to determine for the customer whether or not a different number of stops or a lower fair class (economy rather than business) can allow for the desired number of tickets to be obtained or allow for purchase at all. If a flight matching some of the user inputs is available, at step 122 the customer is offered the option to purchase/book the flight. At this point, the customer may either book the flight at step 126 or decline. If the customer does not have sufficient miles to purchase any relevant flights, at step 128 the customer is asked if he/she desires to make changes to the criteria information originally input at step 106. If the customer declines to purchase the flight, at step 128 the customer is asked if he/she desires to make changes to the criteria information originally input at step 106. If the customer does wish to do so, he/she is returned to step 106 to enter new information and repeat process 100. Otherwise, the process 100 is terminated at 130.

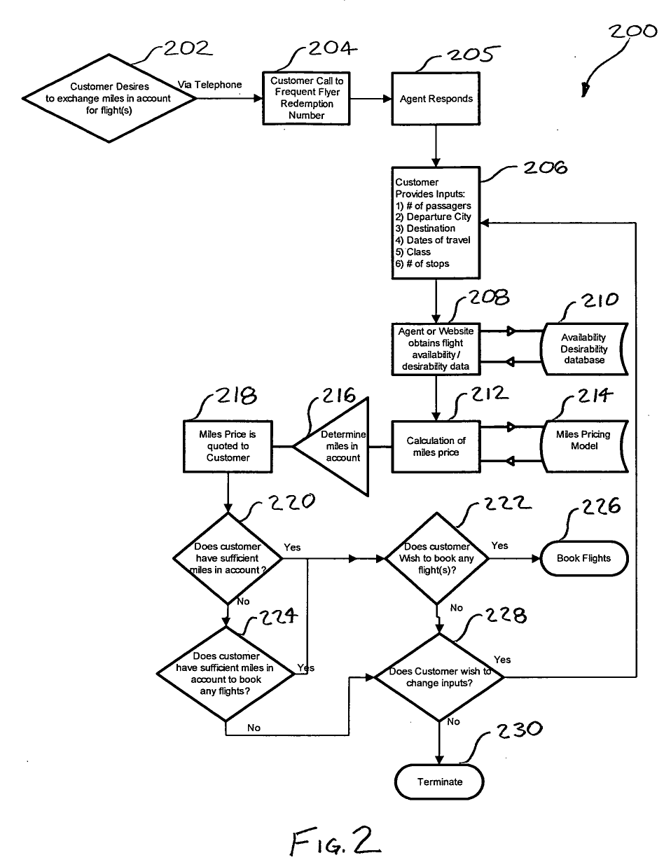

The present invention is also directed to a process for redeeming frequent flier miles over the telephone, a representative embodiment of such process is illustrated schematically in the flow chart of FIG. 2 and labeled 200. At step 202, process 200 begins with a frequent flier customer deciding to redeem/exchange miles for a flight. At step 204, the customer places a call to the airline, where at step 205 an agent responds. Through the agent, at step 206 the customer provides input information including the number of passengers that desire travel, the departure and destination cities, the dates of travel, the level of flight accommodations (e.g., coach, first class), and the allowable number of stops for the flight. This information is received, at step 208, and utilized, at step 210, to search a database of available flights to locate those flights matching the criteria entered by the user. The search of step 210 can be performed either by physically or electronically accesses a database.

When one or more flights matching the entered criteria have been identified, the number of frequent flier miles required to purchase the flight is calculated. The flight information is input at step 212 into a “miles pricing model” 214, which returns the appropriate cost in frequent flier miles for the flight. The miles pricing model 214 incorporates concepts related to demand for flights in calculating a “miles price” for the particular flight in question. At step 216, the number of frequent flier miles that the customer has accumulated is determined, typically by examining a frequent flier miles account specific to the airline. At step 218, the miles price for the flight(s) is quoted to the customer. At step 220, the miles price is compared to the number of miles in the customer's frequent flier account to determine whether the customer has sufficient miles to purchase the flight. As before, this comparison can be done manually or can be automated into an electronic process. If the customer does have sufficient miles to purchase a flight, at step 222 the customer is offered the option to purchase/book the flight. At this point, the customer may either book the flight at step 226 or decline. If the customer declines to purchase the flight, at step 228 the customer is asked if he/she desires to make changes to the criteria information originally input at step 206. If the customer does wish to do so, he/she is returned to step 206 to enter new information and repeat process 100. Otherwise, the process 200 is terminated at 230.

If, at step 220, it is determined that the customer does not have a sufficient number of miles to purchase any flight matching the entered criteria, it is determined at step 224 whether the customer has sufficient miles to book any flights matching at least some of the entered criteria. If a flight matching some of the user inputs is available, at step 222 the customer is offered the option to purchase/book the flight. At this point, the customer may either book the flight at step 226 or decline. If the customer does not have sufficient miles to purchase any relevant flights, at step 228 the customer is asked if he/she desires to make changes to the criteria information originally input at step 206. If the customer declines to purchase the flight, at step 228 the customer is asked if he/she desires to make changes to the criteria information originally input at step 206. If the customer does wish to do so, he/she is returned to step 206 to enter new information and repeat process 200. Otherwise, the process 200 is terminated at 230.

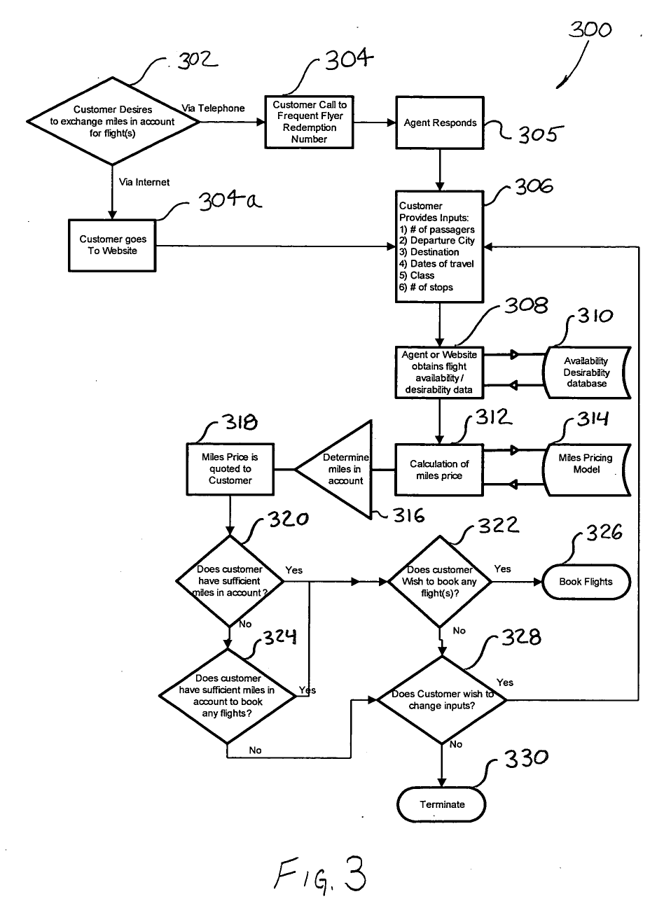

It should be readily apparent that, while the processes utilizing the Internet and the telephone have been listed separately, a process making both Internet and telephone options available to users is also within the scope of the disclosure, as depicted in FIG. 3. In this embodiment of the invention 300, a customer can determine whether he/she would rather interact with the airline via telephone communication 304 or the Internet 304a at step 302. The remaining steps of the method can be similar to those illustrated with respect to FIG. 1 and FIG. 2. Further, both processes can be substantially or completely automated, as well as substantially or completely integrated, through the development of appropriate software.

To further clarify the above-described processes for flight purchase through frequent flier miles redemption, several examples of the application of this process are included below.

### EXAMPLE 1

A customer and spouse wish to travel from JFK airport to Honolulu, Hi. on December 1 and return December 17, traveling business class on a direct flight. The customer has 850,000 miles in his frequent-flier account and wishes to use these to purchase the flight. The customer calls the airline's frequent-flier redemption telephone number up on July 1. The airline agent checks the availability and finds a flight with 75% of the seats available. However, this flight is rated “highly desirable” by the airline, meaning that it is expected to be a popular flight. The agent then inputs the data from the customer, the flight availability data, the desirability rating, and the date of the call into the miles pricing model. The model says that the cost per ticket is 200,000 miles. The agent also informs the customer of both the miles price and the dollar price for the desired tickets. The customer, having sufficient miles in his account and believing that the miles price is more reasonable than the price in dollars, books the flight using miles.

### EXAMPLE 2

A customer and spouse wish to travel from JFK airport to Honolulu, Hi. on Saturday, December 1 and return Monday, December 17, traveling business class on a direct flight. The customer has 350,000 miles in his frequent-flier account and wishes to use these to purchase the flight. The customer calls the airline's frequent-flier redemption telephone number up on July 1. The airline agent checks the availability and finds a flight with 75% of the seats available. However, this flight is rated “highly desirable” by the airline, meaning that it is expected to be a popular flight. The miles pricing model says that the cost per ticket is 200,000 miles, and the agent informs the customer that he has insufficient miles in his account and would only be able to obtain one ticket. The agent also quotes the customer of the price in dollars for each ticket. However the agent informs the customer that the miles pricing model indicates that if the customer wishes to fly economy for those dates, the miles needed per ticket would be 160,000. The customer could also fly with one stopover in Atlanta for 165,000 miles per ticket. In addition, the customer could change the departure date from Saturday to Thursday (two days earlier) and fly for 175,000 miles per ticket. The customer chooses the most desirable proposal (whether involving frequent flier miles redemption or dollars) and books the tickets.

### EXAMPLE 3

A customer and spouse wish to travel from JFK airport to Honolulu, Hi. on December 1 and return December 17, traveling business class on a direct flight. The customer has 850,000 miles in his frequent-flier account and wishes to use these to purchase the flight. The customer calls the airline's frequent-flier redemption telephone number up on November 15. The airline agent checks the availability and finds a flight with 10% of the seats available. However, this flight is rated “highly desirable” by the airline, meaning that it is expected to be a popular flight. The miles pricing model indicates that the cost per ticket is 300,000 miles, and this miles price is reported to the customer. The agent also informs the customer of the price per ticket in dollars. The customer decides that he would rather spend the miles than the dollars and books the tickets.

While the specific Examples illustrated herein are generally directed to redeeming frequent flier miles for purposes of airline tickets, it will be understood that the principles of the method, system and machine readable program of the invention is equally applicable to redeeming other goods and services using frequent flier miles. Such goods and services can include but are not limited to, for example, rental cars, hotel stays, and using miles to purchase any number of goods including gift cards, appliances, electronics, food items, and meals in restaurants, among others.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The block diagrams herein, such as those depicted in FIGS. 1-3, represent conceptual views of illustrative circuitry and software embodying the principles of the invention. Thus the functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicants thus regard any means which can provide those functionalities as equivalent to those shown herein.

Similarly, it will be appreciated that the system flows in the flow charts depicted in FIGS. 1-3, for example, shown herein, represent various processes which may be substantially represented in computer-readable medium and so executed by a computer or processor, whether or not such computer or processor is explicitly shown. Moreover, in the flowcharts shown herein, the various blocks can be understood as representing not only processing and/or other functions but, alternatively, as blocks of program code that carry out such processing or functions.

The methods and systems of the present invention, as described above and shown in the drawings, provide for a method, system, machine readable program and graphical user interface with superior functionality that can facilitate the valuation and redemption of frequent flier miles. It will be apparent to those skilled in the art that various modifications and variations can be made in the embodiments of the present invention without departing from the spirit or scope of the invention. Thus, it is intended that the present invention include modifications and variations that are within the scope of the appended claims and their equivalents.

What is claimed is:

1. A method for determining a number of frequent flier miles necessary to complete a transaction to acquire a good or service, the method comprising the steps of:
a) determining at least one of a demand and a cost for the good or service based on information affecting the value of the good or service; and
b) establishing a number of miles that correlates to the determined demand or cost.

2. The method of claim 1, wherein the good or service relates to the purchase or upgrade of an airline ticket.

3. The method of claim 2, wherein the information affecting the value of the good or service includes at least one of market data and flight data related to a travel destination associated with the ticket.

4. A method of redeeming frequent flier miles to purchase a good or service comprising the steps of:
a) receiving a first set of information from a user including one or more preferences of the user;
b) determining availability of a good or a service substantially consistent with the preferences received from the user;
c) determining a number of frequent flier miles necessary to purchase the good or service by performing the steps of:
i) determining at least one of demand and a cost for the good or service based on information affecting the value of the good or service; and
ii) establishing a number of miles that correlates to the determined demand or cost; and
d) sending a signal representative of the number of miles that correlates to the demand or cost.

5. The method of claim 4, wherein the signal is sent to the user.

6. The method of claim 4, wherein the good or service relates to the purchase or upgrade of an airline ticket.

7. The method of claim 6, wherein the first set of information includes travel preferences of the user.

8. The method of claim 6, wherein the demand is determined for an airline ticket based on availability information and past market data related to a travel destination associated with the ticket.

9. The method of claim 4, wherein the method is implemented over a telephone network.

10. The method of claim 4, wherein the method is implemented over the internet.

11. The method of claim 4, wherein the number of frequent flier miles necessary to purchase the good or service is determined using a machine readable program tangibly embodied on a computer readable medium.

12. A system for redeeming frequent flier miles to purchase a good or service comprising:
a) means for receiving a first set of information from a user including one or more preferences of the user;
b) means for determining availability of a good or a service substantially consistent with the preferences received from the user;
c) means for determining a number of frequent flier miles necessary to purchase the good or service including:
i) means for determining at least one of a demand and a cost for the good or service based on information affecting the value of the good or service; and
ii) means for establishing a number of miles that correlates to the determined demand or cost; and
d) means for sending a signal representative of the number of miles that correlates to the demand or cost.

13. The system of claim 12, wherein the means for receiving the first set of information includes a telephonic interface to permit a user to specify the user preferences.

14. The system of claim 12, wherein the means for receiving the first set of information includes a database adapted and configured to receive information over the internet entered into a graphical user interface by a user.

15. The system of claim 12, further comprising means for comparing the number of miles that correlates to the demand or cost with the number of miles in an account of the user.

16. The system of claim 15, further comprising means for determining if the user has sufficient miles in the user account to obtain any available goods or services.

17. The system of claim 15, further comprising means for permitting the user to change the user preferences.

18. The system of claim 12, further comprising means to permit the user to purchase the goods or services.

19. The system of claim 12, wherein the means for sending a signal sends the signal to the user.

20. The system of claim 19, wherein the means for sending a signal sends the signal to the user over at least one of the internet and a telephone line.
